(19) United States
(12) Patent Application Publication
(10) Pub. No.: US 2007/0156947 A1
(43) Pub. Date: Jul. 5, 2007

(54) Address translation scheme based on bank address bits for a multi-processor, single channel memory system

(75) Inventors: Karthikeyan Vaithiananthan, Chandler, AZ (US); Dharmin Y. Parikh, Chandler, AZ (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/323,421

(22) Filed: Dec. 29, 2005

(51) Int. Cl. G06F 12/06

(52) U.S. Cl. 711/5

(57) ABSTRACT

A method, device, and system are disclosed. In one embodiment, the method comprises mapping at least one bank in a memory to a first device for exclusive use, and mapping at least one other bank in the memory to a second device for exclusive use.

### FIELD OF THE INVENTION

The invention relates to computer system memory. More specifically, the invention relates to translating virtual addresses to physical memory addresses based on memory bank designation.

### BACKGROUND OF THE INVENTION

Present computer systems have increasingly complex configurations. Not only is there a central processor executing software application code, but it is becoming more common to have two or more processors in a computer system. A second processor may be a fully independent central processor or it could also be another agent within the system that performs more specialized functions such as graphics processors, network processors, system management processors, or any one of a number of other types of processors. Depending on the system configuration, a system with two or more processors may share the system memory. This can create efficiency problems because two or more processors with an equal or near equal arbitration policy can potentially lead to a phenomenon called memory page thrashing.

In one possible system configuration, there are two processors. Both processors share a single channel double data rate (DDR) direct inline memory module (DIMM). A single channel DDR DIMM is limited to eight memory banks. Though there are eight banks, only four of the eight banks can be open at any given time. A bank is open when there is a particular page within the bank that is open and accessible by one of the two processors. When two processing agents access a single channel of memory, they end up competing for the same set of banks. This results in frequent page open and close operations, affecting the pipelined memory throughput.

For example, consider two processors, processor 1 and processor 2, doing a burst read to the same bank. Processor 1 opens a page, Page 0, in Bank 0 and reads a cache line. In the case of a 50% arbitration policy between the two processors, in the next cycle, processor 2 closes Page 0 and opens another page, Page 1, to read a cache line. This is followed by processor 1 which closes Page 1 and opens Page 0 to continue its burst. Even though the two processors are not interacting often with each other, they are hurting each other's performance and also bringing down the memory system efficiency. This creates a page thrashing phenomenon because only one page per bank can be open at any given time.

### BRIEF DESCRIPTION OF THE DRAWINGS

The present invention is illustrated by way of example and is not limited by the figures of the accompanying drawings, in which like references indicate similar elements, and in which:

FIG. 1 is a block diagram of a computer system which may be used with embodiments of the present invention;

FIG. 2 illustrates one embodiment of a computer system with two processors coupled to a memory controller and address translator;

FIG. 3 illustrates one embodiment of a modification to the allocation of the banks of memory in a computer system with two processors coupled to a memory controller and address translator;

FIG. 4 illustrates an embodiment of a computer system in which a first processor and second processor are connected to a memory controller and address translator and the first processor is allocated more memory banks than the second processor;

FIG. 5 illustrates an embodiment of a computer system in which a first processor and second processor are connected to a memory controller and address translator, and furthermore the first processor is allocated exclusive memory banks, the second processor is allocated exclusive memory banks, and the remaining banks are allocated to be shared between the first and second processors;

FIG. 6 illustrates one embodiment of a virtual memory space to physical memory space per bank mapping of system memory;

FIG. 7 is a flow diagram of an embodiment of a method to map banks in a memory to multiple processors; and

FIG. 8 is a flow diagram of an embodiment of a method to receive and translate memory requests from two separate processors to separate banks of a memory.

### DETAILED DESCRIPTION OF THE INVENTION

Embodiments of a method, device, and system for an address translation scheme based on bank address bits for a multi-processor, single channel memory system are disclosed. In the following description, numerous specific details are set forth. However, it is understood that embodiments may be practiced without these specific details. In other instances, well-known elements, specifications, and protocols have not been discussed in detail in order to avoid obscuring the present invention.

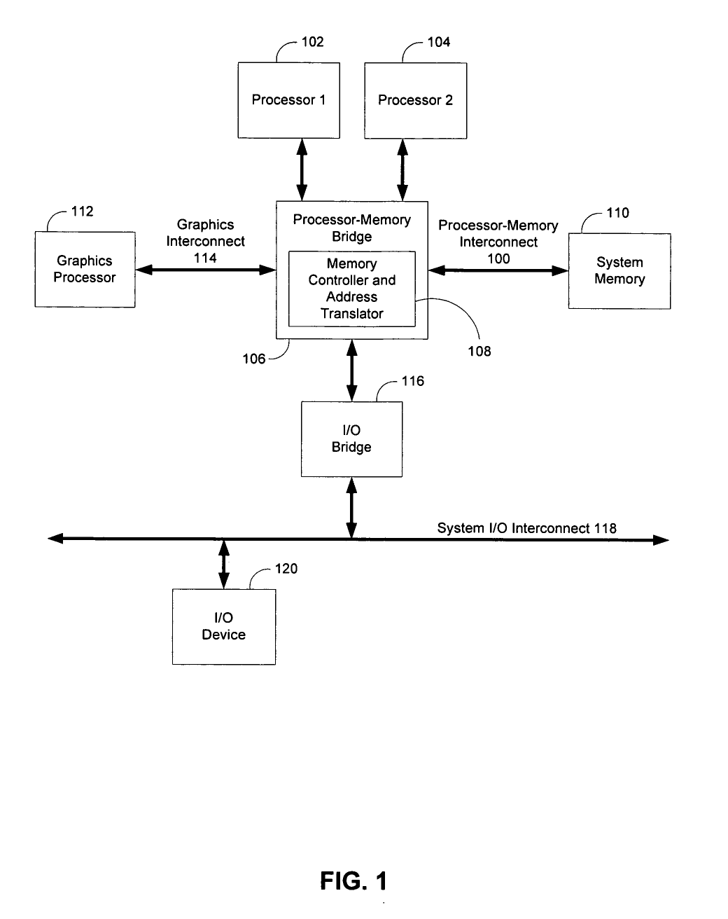

FIG. 1 is a block diagram of a computer system which may be used with embodiments of the present invention. The computer system comprises a processor-memory interconnect 100 for communication between different agents coupled to interconnect 100, such as processors, bridges, memory devices, etc. Processor-memory interconnect 100 includes specific interconnect lines that send arbitration, address, data, and control information (not shown). In one embodiment, processor 1 (102) and processor 2 (104) are coupled to processor-memory interconnect 100 through processor-memory bridge 106. In another embodiment, there is a single central processor coupled to processor-memory interconnect (a single processor is not shown in this figure). In different embodiments, the processors in FIG. 1, processors 1 (102) and 2 (104) can be central processors, network processors, graphics processors, system management processors, or any other type of relevant processors that can be bus master devices. Though it is common that at least one of processor 1 (102) and 2 (104) is a central processor.

Processor-memory interconnect 100 provides processor 1 (102), processor 2 (104), and other devices access to the memory subsystem. In one embodiment, a memory controller and address translator unit 108 that controls access and translates addresses to system memory 110 is located on the same chip as processor-memory bridge 106. In another embodiment, there are two memory controllers, each of which are located on the same chip as processor 1 (102) and processor 2 (104) respectively (multiple memory controllers are not shown in this figure). Information, instructions, and other data may be stored in system memory 110 for use by processor 1 (102), processor 2 (104), as well as many other potential devices. In one embodiment, a graphics processor 112 is coupled to processor-memory bridge 106 through a graphics interconnect 114.

I/O devices, such as I/O device 120, are coupled to system I/O interconnect 118 and to processor-memory interconnect 100 through I/O bridge 116 and processor-memory bridge 106. In different embodiments, I/O device 120 could be a network interface card, an audio device, or one of many other I/O devices. I/O Bridge 116 is coupled to processor-memory interconnect 100 (through processor-memory bridge 106) and system I/O interconnect 118 to provide an interface for a device on one interconnect to communicate with a device on the other interconnect.

In one embodiment, system memory 110 is a direct inline memory module (DIMM). In different embodiments, the DIMM could be a double data rate (DDR) DIMM, a DDR2 DIMM, or any other of a number of types of memories that implement a memory bank scheme. In one embodiment, there is only one DIMM module residing in the system. In another embodiment, there are multiple DIMM modules residing in the system. In different embodiments, a DDR DIMM can be a single channel DDR DIMM or a multi-channel DDR DIMM.

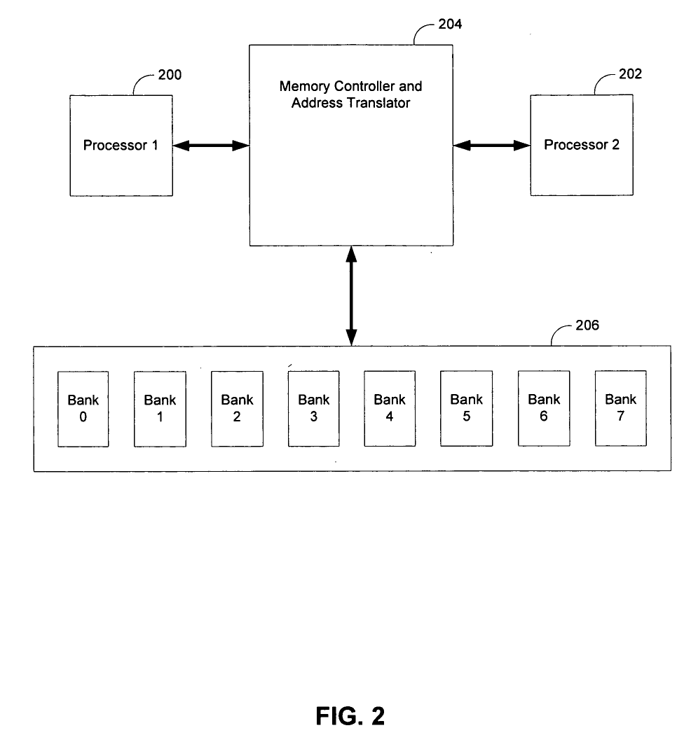

Now turning to the next figure, FIG. 2 illustrates one embodiment of a computer system with two processors, processor 1 (200) and processor 2 (202), coupled to a memory controller and address translator 204. As in FIG. 1, in one embodiment, the memory controller and address translator 204 is located on the same chip as a processor-memory bridge. Additionally, the memory controller and address translator 204 is coupled to a single DDR DIMM 206. The memory in a DDR DIMM is partitioned into banks. A single channel DDR DIMM is limited to eight banks, as is shown in FIG. 2. Due to certain limitations in DDR memory, not all banks are able to be open at once. For example, in a single channel DDR DIMM with eight banks, as shown in FIG. 2, only four banks can be opened simultaneously. Thus, for a given window of time, because only four banks are open, bubbles are created in the command pipeline. The two processors, processor 1 (200) and processor 2 (202), end up competing for the same banks when accessing this type of a memory system. This competition for banks creates page thrashing as described above in detail.

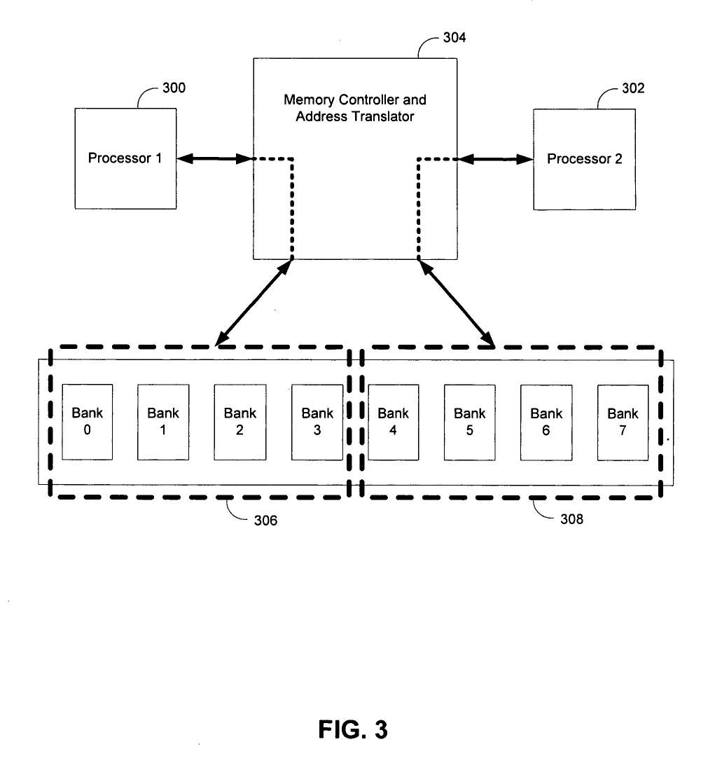

Now turning to the next figure, FIG. 3 illustrates one embodiment of a modification to the allocation of the banks of memory in a computer system with two processors, processor 1 (300) and processor 2 (302), coupled to a memory controller and address translator 304. Processor 1 (300) and processor 2 (302) access a single channel DDR DIMM through the memory controller and address translator 304. In this embodiment, the memory controller and address translator 304 allocates memory Banks 0-3 (306) to be accessible only by processor 1 (300) and allocates memory Banks 4-7 (308) to be accessible only by processor 2 (302). In one embodiment, this can be accomplished by creating exclusive regions of memory for either processor 1 (300) or processor 2 (302) within regions of memory that are separated by the address bits associated with memory banks. For example, in a 1 GB DIMM that has eight banks, the banks are normally divided in contiguous fashion so the lowest 128 MB (0-127 MB of addresses) of memory would be Bank 0, the next 128 MB, (128-255 MB of addresses) of memory would be Bank 1, and so on. Thus, in this example, the 3 bits associated with the base addresses of these 8 banks (bits 17-19 of an address scheme) would be bank selector bits and each of the eight combinations would be restricted and mapped to a particular processor.

Thus, in this embodiment the mutually exclusive banks of memory, accessible to either processor 1 (300) or processor 2 (302) but not both processors, eliminates the page thrashing issue described above in reference to FIG. 2. For example, processor 1 opens a page, Page 0, in Bank 0 and reads a cache line. Due to a 50% arbitration between the two processors, in the next cycle, processor 2 (302) opens another page to read a cache line. Though, because the banks in the single channel DDR DIMM are mutually exclusive in this embodiment, processor 2 (302) can only open pages in Banks 4-7, for example Page 0 in Bank 4. Therefore, Page 0 in Bank 0, the page that processor 1 (300) had open to complete a burst read, does not need to close. Both pages can remain open through multiple cycles of both processors and the significant page thrashing is eliminated.

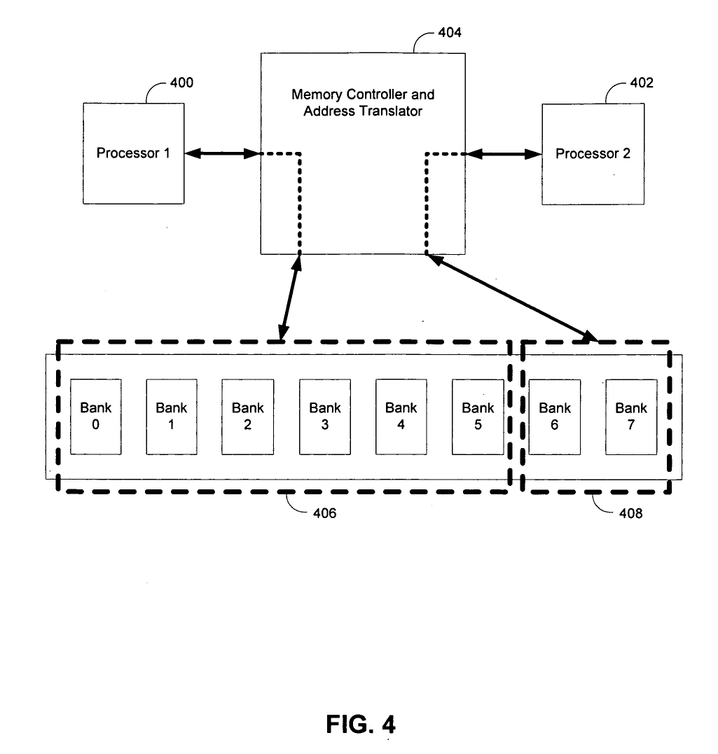

In FIG. 3, the number of banks allocated to processor 1 (300) and processor 2 (302) are equal. Though, in other embodiments the banks allocated are not equal. For example, if one processor is a general purpose central processor and the other processor is a smaller, specialized processor, it may be beneficial to allocate a greater percentage of banks to the central processor and a lower percentage of banks to the specialized processor. Now turning to the next figure, FIG. 4 shows just such an embodiment. FIG. 4 illustrates an embodiment of a computer system in which a first processor and second processor are connected to a memory controller and address translator and the first processor is allocated more memory banks than the second processor.

In this embodiment, the memory controller and address translator 404 allocates memory Banks 0-5 (406) to be accessible only by processor 1 (400) and allocates memory Banks 6-7 (408) to be accessible only by processor 2 (402). Thus, in this embodiment, out of the entire amount of physical memory present in the computer system, processor 1 (400) is allocated 75% of the memory banks and processor 2 (402) is allocated 25% of the memory banks.

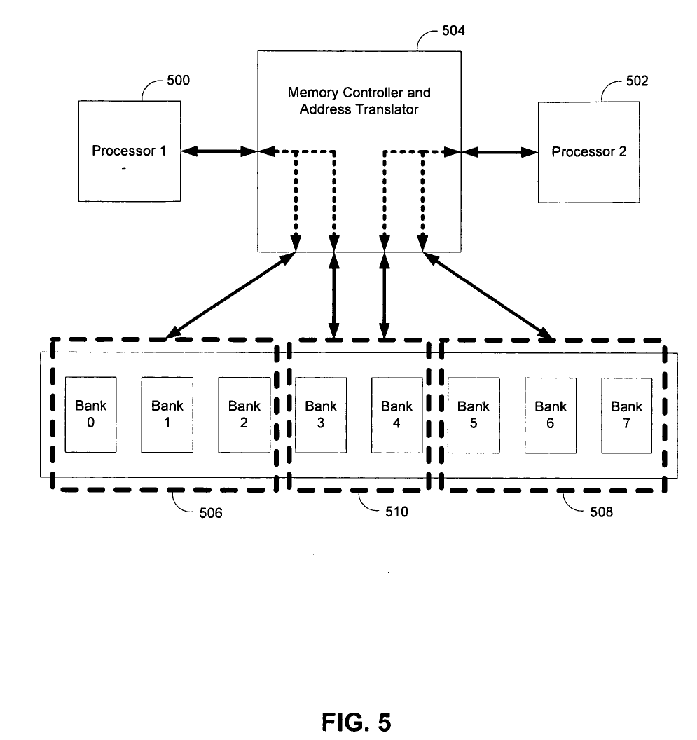

It may be beneficial to additionally have one or more memory banks in a DIMM accessible by both processors in the computer system. Thus, in yet another embodiment, one or more banks are allocated to be accessible by both processors. Now turning to the next figure, FIG. 5 shows such an embodiment. FIG. 5 illustrates an embodiment of a computer system in which a first processor and second processor are connected to a memory controller and address translator, and furthermore the first processor is allocated exclusive memory banks, the second processor is allocated exclusive memory banks, and the remaining banks are allocated to be shared between the first and second processors.

In this embodiment, the memory controller and address translator 504 allocates memory Banks 0-3 (506) to be accessible only by processor 1 (500), allocates memory Banks 5-7 (508) to be accessible only by processor 2 (502), and allocates memory Banks 3-4 to be accessible by both processors 1 (500) and 2 (502). Thus, in this embodiment, out of the entire amount of physical memory present in the computer system, processor 1 (500) is allocated exclusive use of 37.5% of the memory banks, processor 2 (502) is allocated exclusive use of 37.5% of the memory banks, and processors 1 500) and 2 (502) are allocated shared use of the remaining 25% of the memory banks. In another embodiment, there is a single central processor and a second device that is not a central processor accessing the memory. In yet another embodiment, there are two devices accessing the memory, both of which are not central processors. In yet another embodiment, there are more than two devices or processors accessing the memory. The descriptions of the embodiments in reference to FIGS. 1-5 can be modified to describe any of these implementations (e.g., one processor/one device, two devices, three or more processors or devices, etc.).

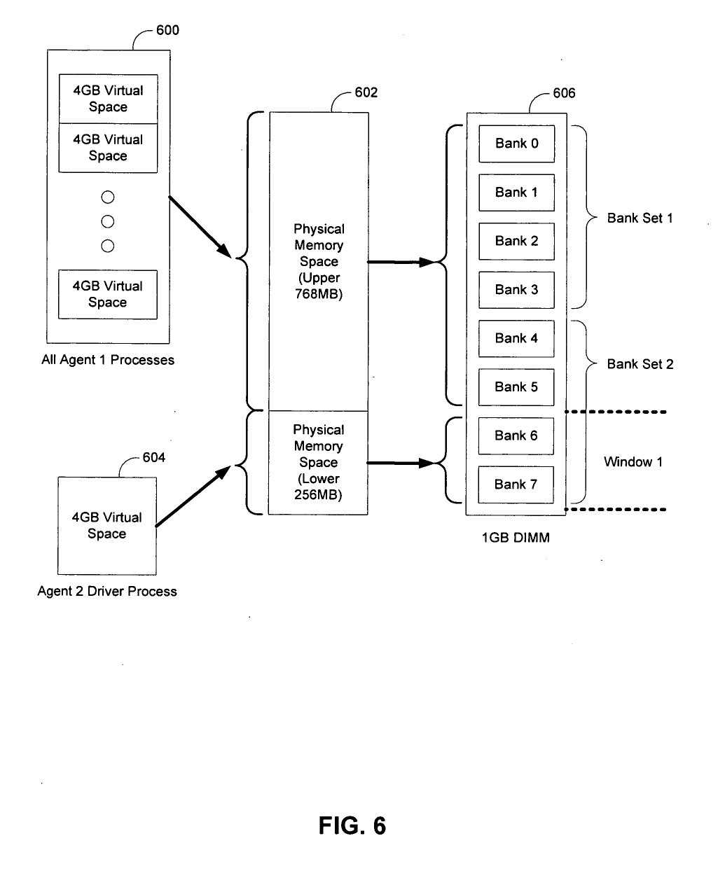

Turning now to the next figure, FIG. 6 illustrates one embodiment of a virtual memory space to physical memory space per bank mapping of system memory. Consider a two processor system as shown in FIGS. 1-5. In one embodiment, processor 1 is an IA32 CPU, assigned as the bootstrap processor, that runs a native operating system and processor 2 is a non IA32 processor which does not have a native operating system (OS). In this embodiment, the computer system has a one gigabyte (1 GB) single channel DDR DIMM made of 8 banks. Banks 0-3 are referred to as Bank Set 1 and Banks 4-7 are referred to as Bank Set 2.

When the OS boots up in the bootstrap processor (processor 1), it assigns virtual memory space up to 4 GB to each process that runs in processor 1 (600). The Virtual to Physical (V2P) mapping table maps this virtual memory address space to the physical memory address space (602). In this embodiment, the OS sees processor 2 as a PCI device and assigns virtual memory space 604 (up to 4 GB) to the device driver which drives processor 2. In this embodiment, the processor 2 driver is a special kernel process which is allowed to lock a window, Window 1, in the physical memory address space 602, which corresponds to a portion of physical memory 606 (see Window 1 at bottom of physical memory 606). Window 1 is never swapped out of the physical memory by other processes. The physical addresses for the memory accesses of processor 2 are contained within Window 1.

In one embodiment, the address for the beginning of Window 1, as well as its length, can be written and stored as a register file in the memory controller and address translator unit. In other embodiments, these values can be stored within or external to the memory controller and address translator unit. In addition, the values can be stored in any medium capable of storing information for a computer system.

Returning to FIG. 6, the address translator unit translates Window 1 to a portion or the entire amount of Bank Set 2. When the address translator unit receives any transaction that falls in this window, it routes the transaction to Window 1 in Bank Set 2. All other accesses are routed to Bank Set 1 and the complement of Window 1 in Bank Set 2.

The embodiment in FIG. 6 is illustrative of the example as set forth in FIG. 4. This example could be easily modified to illustrate the examples in FIGS. 3 and 5 or any other possible combination of processors, DIMMs, and bank allocations.

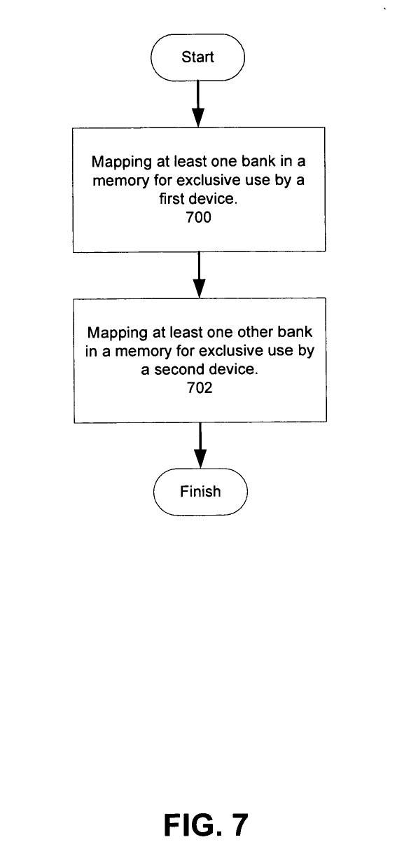

Now turning to the next figure, FIG. 7 is a flow diagram of an embodiment of a method to map banks in a memory to multiple processors. The process is performed by processing logic that may comprise hardware (circuitry, dedicated logic, etc.), software (such as is run on a general purpose computer system or a dedicated machine), or a combination of both. The memory bank mapping process begins by processing logic mapping at least one bank in a memory for exclusive use by a first device (processing step 700). As mentioned above in reference to FIG. 1, the memory can be any type of memory that utilizes a memory bank scheme. The first device can be a central processor, a network processor, a graphics processor, a system management processor, or any other type of relevant processor that can be a bus master.

The process continues by processing logic mapping at least one bank in the memory for exclusive use by a second device (processing step 702). The second device can also be a central processor, a network processor, a graphics processor, a system management processor, or any other type of relevant processor or device that can be a bus master. In different embodiments, either processor 1 or processor 2 would likely be a boot strap processor to load the OS, though this is not necessary if there is an additional processor apart from processors 1 and 2 to accomplish this task. The process is finished at this point. In one embodiment, this process is implemented during system boot up. In another embodiment, in a system with more than two processors, this process could continue by designating more banks of memory to be exclusively used by additional processors.

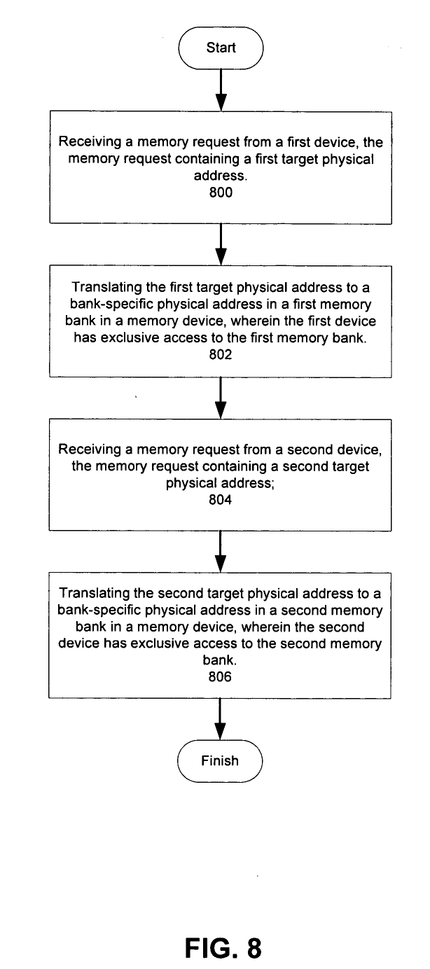

Now turning to the next figure, FIG. 8 is a flow diagram of an embodiment of a method to receive and translate memory requests from two separate processors to separate banks of a memory. The process is performed by processing logic that may comprise hardware (circuitry, dedicated logic, etc.), software (such as is run on a general purpose computer system or a dedicated machine), or a combination of both. The memory request reception and translation process begins by processing logic receiving a memory request from a first device, the memory request containing a first target physical address (processing step 800). Next, the process continues by processing logic translating the first target physical address to a bank-specific physical address in a first memory bank in a memory device, wherein the first device has exclusive access to the first memory bank (processing step 802). Next, the process continues by processing logic receiving a memory request from a second device, the memory request containing a second target physical address (processing step 804).

Finally, the process concludes by processing logic translating the second target physical address to a bank-specific physical address in a second memory bank in a memory device, wherein the second device has exclusive access to the second memory bank (processing step 806). In many embodiments, this process may take place multiple times. In different embodiments, processing steps 800 and 802 may repeat multiple times prior to processing steps 804 and 806 taking place (or vice versa) if the first device and second device are not set up with a 50% arbitration policy. In different embodiments, devices 1 and 2 can be any of the processor devices described above in reference to FIGS. 1 and 7. Additionally, in different embodiments, the memory can be any of the memories described above again in reference to FIGS. 1 and 7.

Thus, embodiments of a method, device, and system for an address translation scheme based on bank address bits for a multi-processor, single channel memory system are disclosed. These embodiments have been described with reference to specific exemplary embodiments thereof. Though, the device, method, and system may be implemented with any given protocol with any number of layers. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
mapping one or more banks in a memory to a first device for exclusive use; and
mapping one or more other banks in the memory to a second device for exclusive use.

2. The method of claim 1, further comprising mapping one or more other banks in the memory, separate from the one or more banks mapped to the first device for exclusive use and from the one or more banks mapped to the second device for exclusive use, for shared use by the first device and the second device.

3. The method of claim 2, wherein the one or more banks mapped to the first device for exclusive use, the one or more banks mapped to the second device for exclusive use, and the one or more banks mapped to the first device and second device for shared use are the complete set of banks available for use in the memory.

4. The method of claim 2, wherein the one or more banks mapped to the first device for exclusive use, the one or more banks mapped to the second device for exclusive use, arid the one or more banks mapped to the first device and second device for shared use are not the complete set of banks available for use in the memory.

5. The method of claim 1, wherein mapping the banks in the memory occurs during the power on sequence of a computer system that the memory is located within.

6. The method of claim 1, further comprising:
loading an operating system into a portion of the memory mapped to the first device for exclusive use;
once the operating system is loaded, loading one or more processes associated with the first device into a portion of the memory exclusively accessible by the first device; and
loading a device driver process that drives the second device into a portion of the memory exclusively accessible by the second device.

7. A method, comprising:
receiving a memory request from a first device, the memory request containing a first target physical address;
translating the first target physical address to a bank-specific physical address in a first memory bank in a memory device, wherein the first device has exclusive access to the first memory bank;
receiving a memory request from a second device, the memory request containing a second target physical address; and
translating the second target physical address to a bank-specific physical address in a second memory bank in the memory device, wherein the second device has exclusive access to the second memory bank.

8. The method of claim 7, further comprising:
receiving a memory request from the first device, the memory request containing a third target physical address;
translating the third target physical address to a bank-specific physical address in a third memory bank in a memory device, wherein the first device and the second device have shared access to the third memory bank;
receiving a memory request from the second device, the memory request containing a fourth target physical address; and
translating the fourth target physical address to a bank-specific physical address in the third memory bank in the memory device.

9. The method of claim 7, further comprising:
loading an operating system into a portion of the memory exclusively accessible by the first device;
once the operating system is loaded, loading one or more processes associated with the first device into a portion of the memory exclusively accessible by the first device; and
loading a device driver process that drives the second device into a portion of memory exclusively accessible by the second device.

10. The method of claim 7, further comprising, prior to receiving the memory requests:
mapping one or more banks in the memory to the first device for exclusive use; and
mapping one or more other banks in the memory to the second device for exclusive use.

11. A device, comprising a memory controller to:
map one or more banks in a memory to a first device for exclusive use; and
map one or more other banks in the memory to a second device for exclusive use.

12. The device of claim 11, wherein the memory controller maps the banks in the memory during the power on sequence of a computer system that the memory is located within.

13. The device of claim 11, wherein the memory controller is further operable to:
load an operating system into a portion of the memory exclusively accessible by the first device;
once the operating system is loaded, load one or more processes associated with the first device into a portion of the memory exclusively accessible by the first device; and
load a device driver process that drives the second device into a portion of the memory exclusively accessible by the second device.

14. A system, comprising;
a bus;
a first processor coupled to the bus;
a second processor coupled to the bus;
a network interface card coupled to the bus;
a memory coupled to the bus;
a chipset coupled to the bus, the chipset comprising a memory controller and address translation unit to:
receive a memory request from the first processor, the memory request containing a first target physical address;
translate the first target physical address to a bank-specific physical address in a first memory bank in the memory, wherein the first processor has exclusive access to the first memory bank;
receive a memory request from the second processor, the memory request containing a second target physical address; and
translate the second target physical address to a bank-specific physical address in a second memory bank in the memory, wherein the second processor has exclusive access to the second memory bank.

15. The system of claim 14, wherein the memory controller and address translation unit is further operable to:
receive a memory request from the first device, the memory request containing a third target physical address;
translate the third target physical address to a bank-specific physical address in a third memory bank in a memory device, wherein the first device and the second device have shared access to the third memory bank;
receive a memory request from the second device, the memory request containing a fourth target physical address; and
translate the fourth target physical address to a bank-specific physical address in the third memory bank in the memory device.

16. The system of claim 14, wherein the memory controller and address translation unit is further operable to:
load an operating system into a portion of the memory exclusively accessible by the first device;
once the operating system is loaded, load one or more processes associated with the first device into a portion of the memory exclusively accessible by the first device; and
load a device driver process that drives the second device into a portion of memory exclusively accessible by the second device.

17. The system of claim 16, wherein the memory controller and address translation unit is further operable to:
at the time of system power on, map each of the banks in the memory to be exclusively accessible to the first processor, to be exclusively accessible to the second processor, or to be accessible to both the first processor and the second processor.
